(19) United States
(12) Patent Application Publication
(10) Pub. No.: US 2017/0104279 A9
(43) Pub. Date: Apr. 13, 2017

(54) ELECTRICAL COMPONENT FOR A HIGH-VOLTAGE INSTALLATION

(71) Applicant: ABB Technology AG, Zurich (CH)

(72) Inventors: Ansgar DAIS, Dietikon (CH); Urs Kruesi, Wiesendangen (CH)

(73) Assignee: ABB Technology AG, Zurich (CH)

(21) Appl. No.: 14/090,509

(22) Filed: Nov. 26, 2013

Related U.S. Application Data
(63) Continuation of application No. PCT/EP2012/055317, filed on Mar. 26, 2012.

(30) Foreign Application Priority Data
May 27, 2011 (EP) 11167911.4

(51) Int. Cl. H01R 9/05

(52) U.S. Cl. CPC H01R 9/05

(57) ABSTRACT

Exemplary embodiments are directed to an electrical component for a high-voltage installation. The electrical component in a coaxial arrangement, has an electrical conductor which extends along an axis and is connected to high-voltage potential and a rigid insulating body. The insulting body is fastened on the electrical conductor and surrounds the electrical conductor. A mounting flange is fastened on the insulating body, and is connected to ground potential. A dome-shaped control electrode is electrically connectively connected to the electrical conductor and is fastened to one end of the electrical conductor. During operation of the installation, the control electrode controls the electrical field between the electrical conductor and the mounting flange. The control electrode is connected non-detachably to the electrical conductor and has a dimensionally stable dome consisting of the solid polymer composition to provide a simple manufacturing process and increase the operational reliability of the component.

### RELATED APPLICATION

This application claims priority as a continuation application under 35 U.S.C. §120 to PCT/EP2012/055317, which was filed as an International Application on Mar. 26, 2012 designating the U.S., and which claims priority to European Application 11167911.4 filed in Europe on May 27, 2011. The content of each prior application is hereby incorporated by reference in its entirety.

### FIELD

The present disclosure relates to an electrical component for a high-voltage installation, and particularly an electrical component including in a coaxial arrangement, an electrical conductor, a rigid insulating body, which is fastened on the electrical conductor and surrounds the electrical conductor, a mounting flange which is fastened externally on the insulating body, and a dome-shaped control electrode, which is electrically conductively connected to the electrical conductor.

### BACKGROUND INFORMATION

A known electrical component can be in the form of a high-voltage bushing. After installation in high-voltage installation the component can connect an electrical conductor of a first part of the installation, which is electrically insulated by a solid, liquid, or gaseous insulating agent from an encapsulation accommodating the insulating agent, to an electrical conductor of a second part of the installation. This electrical conductor can be electrically insulated by the surrounding air, but can also be insulated by another insulating agent which is contained in an encapsulation accommodating the electrical conductor. If the electrical component is in the form of a barrier insulator of a gas-insulated, metal-encapsulated switchgear assembly, such a barrier insulator isolates two compartments of the installation which are filled with insulating gas from one another and connects two electrical conductors carrying a high voltage which are provided in the two compartments to one another.

The mechanical connection between the electrical conductor of the electrical component and the two electrical conductors of the parts to be connected, namely the compartments of the high-voltage installation, can be subjected to an electrical field during operation of the installation, which electrical field acts between the electrical conductors carrying a high voltage and the encapsulation or the mounting flange which is electrically conductively connected to the encapsulation and is therefore largely kept at ground potential. Therefore, the electrical component has a control electrode which is guided in cylinder-symmetrical fashion around this electrical connection and which dielectrically shields this connection and makes the electrical field more uniform.

An electrical component of the type mentioned at the outset in the form of a bushing is described, for example, in EP 1 284 484 B1, EP 1 417 689 B1, EP 1 771 866 B1 and WO 2009/053147 A1. The described bushing is intended for installation in a metallic housing of an electrical high-voltage apparatus, for example, in a transformer housing. This bushing contains, in a coaxial arrangement, an electrical conductor which is extended along an axis and can be connected to high-voltage potential, a rigid insulating body which is fastened on the electrical conductor and surrounds the electrical conductor, and a mounting flange which is fastened externally on the insulating body and can be connected to ground potential.

A capacitor winding is integrated in the insulator. The mounting flange isolates a section of the capacitor winding which is exposed to the air and is arranged above the mounting flange from a section of the capacitor winding which is positioned below the mounting flange and which is arranged, after installation of the bushing in the apparatus, in an insulating agent other than air, such as oil or SF₆. A region of these bushings which is subjected to the ambient air has in each case a shield acting as weathering and radiation protection which encloses that section of the capacitor winding which is positioned above the mounting flange. A control electrode which is fixed on the electrical conductor of the bushing and is merely illustrated in EP 1 284 484 B1 is used for the homogenization of the electrical field at the abovementioned connection point to the electrical conductor of the high-voltage apparatus.

The shield, as shown in EP 1 284 484 B1 and EP 1 771 689 B1, can be integrated in a porcelain insulator or manufactured from silicone and fastened on a fiber-reinforced plastic tube. However, it can also be applied directly to the outer face of the insulator accommodating the capacitor winding, which outer face extends between the mounting flange and an electrical terminal of the bushing, as described in EP 1 417 689 B1 and WO 2009/053147 A1.

WO 2004/001783 A1 discloses a control electrode which is in the form of a circular ring and is formed as a plastic molding and which can be fastened detachably to an electrical device, such as a vacuum interrupter, with the aid of a latching connection. In order to achieve a field-influencing effect, the material of the plastic molding is mixed with additives or the surface of the plastic molding is provided with a metal plating. Details of the manufacture of the plastic molding or the deformation properties thereof are not documented in this prior art.

### SUMMARY

An electrical component for a high-voltage installation is disclosed, comprising: in a coaxial arrangement: an electrical conductor that extends along an axis of the electrical component and is connected to a voltage potential; a rigid insulating body, fastened on the electrical conductor and surrounding the electrical conductor, said rigid insulating body containing a solid polymer composition, which is formed by curing a preformed, free-flowing polymer composition; a mounting flange fastened externally on the rigid insulating body and connected to ground potential, and a dome-shaped control electrode, electrically conductively connected to one end of the electrical conductor, and is configured to control an electric field between the electrical conductor and the mounting flange during operation, wherein the control electrode is connected non-detachably to the electrical conductor, the control electrode having a dimensionally stable dome including the solid polymer composition of the rigid insulating body, and a coating including a cured, electrically conductive enamel is formed at least on the outwardly pointing surface of the dome.

An exemplary electrical component for a high-voltage installation is disclosed, comprising: in a coaxial arrangement: an electrical conductor that extends along an axis and connected to a voltage potential; a rigid insulating body, fastened on the electrical conductor and surrounding the electrical conductor, said rigid insulating body containing a solid polymer composition, which is formed by curing a preformed, free-flowing polymer composition; a mounting flange fastened externally on the rigid insulating body and connected to ground potential, and a control electrode, electrically conductively connected to the electrical conductor and fastened to one end of the electrical conductor, and is configured to control an electric field between the electrical conductor and the mounting flange during operation, wherein the control electrode is elastically deformable and has a dome including an elastomeric plastic, and a coating including a cured, electrically conductive or electrically nonconductive enamel formed at least on an outwardly pointing surface of the dome.

### BRIEF DESCRIPTION OF THE DRAWINGS

The disclosure will be explained in more detail below with reference to drawings, in which:

FIG. 1 shows a plan view of an electrical component in the form of a bushing in accordance with an exemplary embodiment of the disclosure;

FIG. 2 shows an enlarged view of an outlined part of the electrical component shown in FIG. 1, in accordance with an exemplary embodiment of the present disclosure;

FIG. 3 shows a part, illustrated in FIG. 2, of a second electrical component in accordance with an exemplary embodiment of the present disclosure;

FIG. 4 shows a part, illustrated in FIG. 2, of a third electrical component, in accordance with an exemplary embodiment of the present disclosure; and

FIG. 5 shows a part, illustrated in FIGS. 2 to 4, of an electrical component in the form of a barrier insulator in accordance with an exemplary embodiment of the present disclosure.

The same reference symbols also denote functionally identical parts in all of the Figures.

### DETAILED DESCRIPTION

Exemplary embodiments of the present disclosure provide an electrical component for a high-voltage installation includes, in a coaxial arrangement, an electrical conductor which is extended along an axis and can be connected to high-voltage potential and a rigid insulating body, which is fastened on the electrical conductor and surrounds the electrical conductor, said insulating body containing a solid polymer composition which is formed by curing a preformed, free-flowing polymer composition, a mounting flange which is fastened externally on the insulating body and can be connected to ground potential, and a dome-shaped control electrode, which is electrically conductively connected to the electrical conductor, is fastened to one end of the electrical conductor and controls the electrical field between the electrical conductor and the mounting flange during operation of the installation. The component being simple to manufacture and at the same time is characterized by a high level of operational reliability.

In accordance with an exemplary embodiment of the present disclosure, the control electrode can be connected non-detachably to the electrical conductor and have a dimensionally stable dome including the solid polymer composition formed during the preforming and curing of the free-flowing polymer composition, and a coating including a cured, electrically conductive enamel that is applied at least to the outwardly pointing surface of the dome.

In accordance with another exemplary embodiment of the present disclosure, the control electrode can be elastically deformable and have a dome including an elastomeric plastic, and a coating including a cured, electrically conductive or electrically nonconductive enamel that is applied at least to the outwardly pointing surface of the dome.

The exemplary control electrode in the disclosed embodiments can be produced and integrated into the electrical component with little complexity. The manufacture, mounting, and maintenance of the electrical component in accordance with the exemplary embodiments disclosed herein are therefore considerably simplified. By virtue of a cured enamel layer applied to the outer side of the dome, the dielectric strength of the component and correspondingly also the operational reliability are increased in both alternative solutions.

In accordance with an exemplary embodiment of the present disclosure, in addition, the insulating body and the control electrode can be manufactured by jointly preforming and curing the free-flowing polymer composition, can in a casting mold. These two parts which are important for the dielectric response of the component, therefore have largely identical material properties and thus contribute to increased operational reliability. In accordance with another exemplary embodiment of the present disclosure, the control electrode can yield in the case of undesired mechanical loading, for example, an impact. Unintentional damage to the control electrode which cannot be directly identifiable, for example, during transport or during fitting, during operation or during maintenance of the electrical component, is thus largely avoided. Therefore, the control electrode in the second alternative solution increases the operational reliability of the electrical component in accordance with the disclosure.

In order to enable an economical manufacture of the component in accordance with the first alternative solution, the non-detachable connection is in the form of embedding, in which one end of the electrical conductor, which end bears the control electrode, is embedded in the dome manufactured by casting.

The exemplary electrical component in accordance with an embodiment disclosed herein can include, elastomeric plastic that can be electrically conductive and can contain at least one filler having electrically conductive particles. The elastomeric plastic can also be electrically nonconductive, however, and the coating electrically conductive. In any case, the elastomeric plastic can contain silicone or EPDM.

The electrical component in accordance with another exemplary embodiment disclosed herein can be connected detachably to the electrical conductor and can advantageously be in the form of a snap-action or screw-type connection. In yet another exemplary embodiment of the present disclosure, the dome can be connected non-detachably to the electrical conductor and can advantageously be in the form of an adhesive connection or in the form of embedding, in which one end of the electrical conductor, which end bears the control electrode, is embedded in the dome manufactured by casting or shrinking.

The dome and a shield applied to the insulating body can together contain an electrically nonconductive, elastomeric plastic which is formed during manufacture of the component by curing a free-flowing starting composition introduced into a casting mold.

According to exemplary embodiments of the present disclosure, a capacitor winding can be embedded in the solid polymer composition, said capacitor winding including capacitor foils which are electrically insulated from one another and which are held at a distance from one another in the radial direction by an insulating foil wound around the axis or by a plurality of layers of a filament-wound winding body, which layers are guided around the axis.

The electrical component can be a bushing of the high-voltage installation or a barrier insulator of a gas-insulated and metal-encapsulated high-voltage installation.

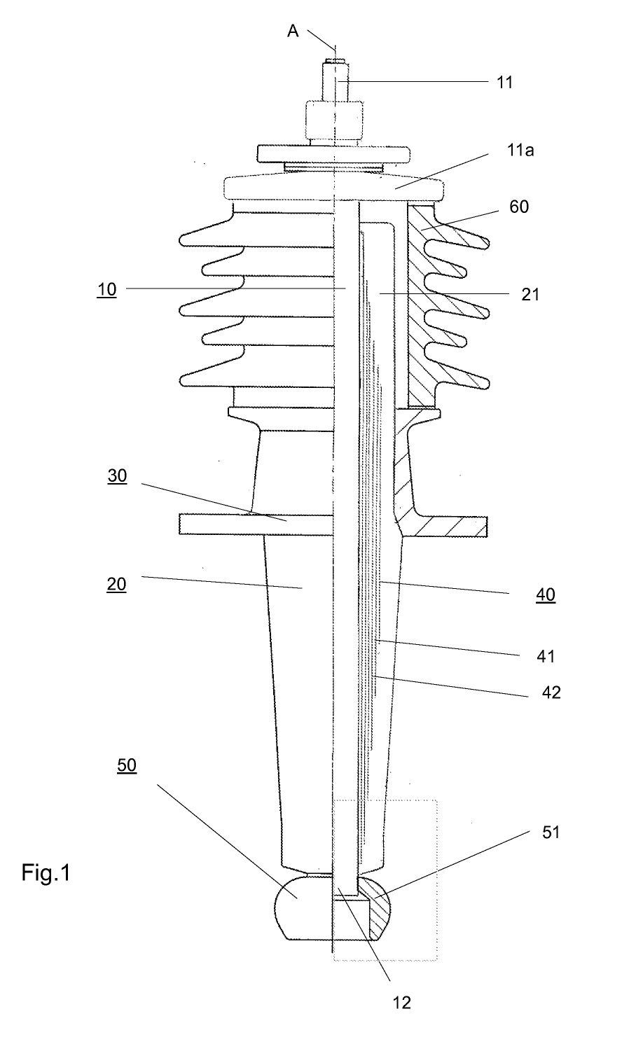

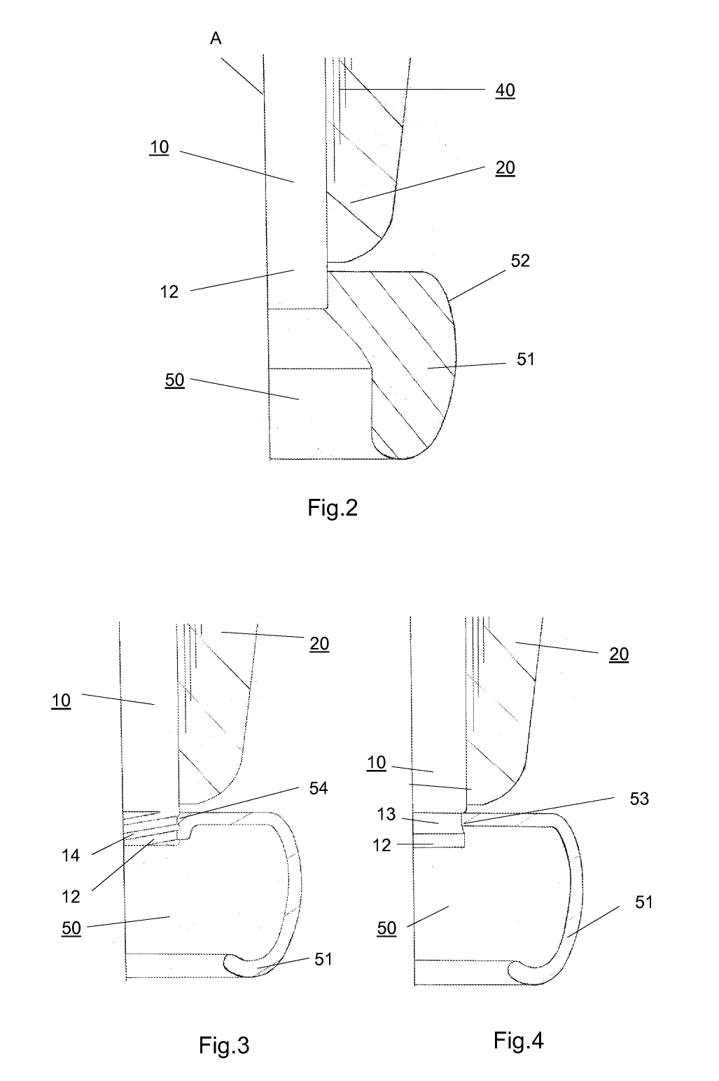

FIG. 1 shows a plan view of an electrical component in the form of a bushing in accordance with an exemplary embodiment of the disclosure. FIG. 2 shows an enlarged view of an outlined part of the electrical component shown in FIG. 1, in accordance with an exemplary embodiment of the present disclosure. The bushing shown in FIGS. 1 and 2 includes, in a coaxial arrangement, an electrical conductor 10 which is guided along the axis A and has an upper end 11, acting as first electrical terminal, and a lower end 12, acting as second electrical terminal. A rigid insulating body 20 can be fastened on the electrical conductor 10 and surround the electrical conductor. A mounting flange 30, which is fastened on the insulating body 20, can be held at a distance from the electrical conductor 10 by the insulating body and can be connected to a metal housing, filled with insulating agent, of an electrical apparatus, for example to a transformer housing. On installation of the bushing into the high-voltage installation, a capacitor winding 40 which can be integrated in the insulating body 20, a control electrode 50 which can be fastened to the lower end 12 of the electrical conductor 10 and can be electrically conductively connected to the electrical conductor 10, and a shield 60, which can surround the insulating body 20 and extends in the axial direction from the mounting flange 30 to a flange 11a, which is electrically conductively connected to the upper end 11 of the electrical conductor 10.

The electrical conductor 10, which can be in the form of a tube or a round bar, can be electrically conductively connected with its lower end 12 to an end of an electrical conductor arranged in the abovementioned metal housing, filled with insulating agent. The upper end 11 of said electrical conductor can be electrically conductively connected to a high-voltage conductor which is insulated by the open air. A shield 60 can include porcelain or a weathering-resistant plastic for example, on the basis of silicone, ethylene propylene diene monomer (EPDM) or cycloaliphatic epoxy and surrounding the insulating body 20 which can act as weathering and radiation protection.

The capacitor winding 40 has capacitor foils 41 which are electrically insulated from one another and which are held at a distance from one another in the radial direction. The insulating clearance can be achieved by an insulating foil 42 wound in the form of a spiral, which insulating foil can consist of paper and/or plastic, or by a plurality of layers of a filament-wound winding body which are guided around the axis A. The capacitor winding 40 can be used for controlling an electrical field which forms during the operation of the bushing between the electrical conductor 10, which can be at a high-voltage potential, and the mounting flange 30 which can be at the potential of the metal housing. The insulating foil 42 and the capacitor foils 41 of the capacitor winding 40 can be embedded in a solid polymer composition 21, which can include filler and which is an epoxy filled with a mineral powder.

The control electrode 50 has a dome 51 including plastic. As shown in FIG. 2 a coating 52 including a cured enamel is applied at least to the upwardly, downwardly and outwardly pointing, e.g., at least the entire outer, surface of the dome 51.

The control electrode 50 is at the potential of the electrical conductor 10. This can be achieved firstly by an electrically conductive plastic forming the dome 51, for example by a polymer filled with electrically conductive particles, such as graphite, metal or metal oxide powders. Secondly, this can also be achieved by virtue of the fact that the cured enamel forming the coating 52 is electrically conductive irrespective of whether the dome 51 is manufactured from an electrically conductive or electrically nonconductive plastic.

The coating 52 that includes the electrically conductive or electrically nonconductive enamel does not enable smooth surface imperfections on the dome 51 to be avoided. Fine control of the electrically conductive field occurring during operation of the high-voltage installation can be achieved, which field acts between the control electrode 50 and the mounting flange 30 or the metal housing which is electrically conductively connected to this flange. In addition, such a coating has a polymeric matrix which protects the surface of the control electrode 50 from mechanical damage, such as scratching, and at the same time considerably reduces the undesired exit of electrons from the control electrode 50. If the coating 52 is formed from cured conductive enamel, electrically conductive particles of the enamel which are at high-voltage potential are embedded in the polymeric matrix and the undesired exit of electrons can also be considerably reduced.

The dome can be fastened at the lower end of the electrical conductor 10 in an axially symmetrical arrangement and, with its wall which is open at the bottom and is spherically curved, shield an electrical conductor connection, by means of which the electrical conductor 10 can be electrically conductively connected with its lower end 12 to the end of the abovementioned electrical conductor of the electrical apparatus, the latter electrical conductor being arranged in a metal housing filled with insulating agent.

In the embodiment shown in FIGS. 1 and 2, the control electrode 50 can be connected non-detachably to the electrical conductor 10. The non-detachable connection can be in the form of embedding, in which the end 12 of the electrical conductor 10, which end bears the control electrode 50, is embedded in the dome 51 manufactured by casting.

Advantageously, the dome 51 can be formed from an elastomeric plastic. The dome 51 can then be performed by introducing a free-flowing starting composition into a casting mold, which can at the same time also be used for the manufacture of the shield. In a subsequent crosslinking process, a dome 51 and possibly at the same time also a shield 60 including the elastomeric plastic can be produced in the casting mold. The shield 60 can be cast directly (not illustrated in FIG. 1) onto the rigid insulating body 20. If the free-flowing casting composition has plastic-containing electrically conductive particles, the dome 51 can be used as control electrode 50 after the application of a coating 52 including a cured, electrically nonconductive enamel onto the outwardly pointing face of the dome. If the dome 51 and the shield 60 have been formed jointly in a casting mold, the dome 51 then can be provided with a coating 52 that includes a cured, electrically conductive enamel at least on the outwardly pointing surface. In the case of undesired mechanical loading, for example in the event of an impact, the control electrode 50 can deform elastically. Damage to the control electrode during transport or during installation of the component can thus largely be avoided. Suitable elastomers are primarily silicone and EPDM, but elastomeric thermoplastics, such as thermoplastic polyurethane, are also possible.

The dome 51 can, however, also be formed in a casting mold shaping the rigid insulating body 20 and the dome 51, and possibly at the same time also the shield 60, into which casting mold, as described in WO 2009/053147 A1, for example, a winding body including the electrical conductor 10 and the capacitor winding 40 can be arranged and is impregnated with the free-flowing polymer composition under vacuum. Then, the free-flowing polymer composition can be cured in the casting mold to form the solid polymer composition 21 and thus also to form the rigid insulating body 20 and the dimensionally stable dome 51, possibly also the shield 60. A seat for the mounting flange 30 can be formed, by material cutting, in the molding thus formed containing the electrical conductor 10, the insulating body 20, the capacitor winding 40, the dome 51 and possibly also the shield 60 and the coating 52, for example with the aid of the conductive varnish, can be applied at least to the outer face of the dome 51.

FIG. 3 shows a part, illustrated in FIG. 2, of a second electrical component in accordance with an exemplary embodiment of the present disclosure. FIG. 4 shows a part, illustrated in FIG. 2, of a third electrical component, in accordance with an exemplary embodiment of the present disclosure. In the exemplary embodiments shown in FIGS. 3 and 4, the connection between the lower end of the electrical conductor 12 and the control electrode 50 can be detachable. As illustrated in FIG. 3, the detachable connection is in the form of a screw-type connection. As can be seen, the control electrode 50 can have a thread 54, which is screwed onto a mating thread 14, which is formed in the end 12 of the electrical conductor. As illustrated in FIG. 4, the detachable connection can also be in the form of a snap-action connection. As can be seen, the control electrode 50 then has a ring-shaped inner rim 53, which snaps into a ring groove 13 which is formed in the lower end 12 of the electrical conductor when the separately manufactured control electrode 50 is pushed on.

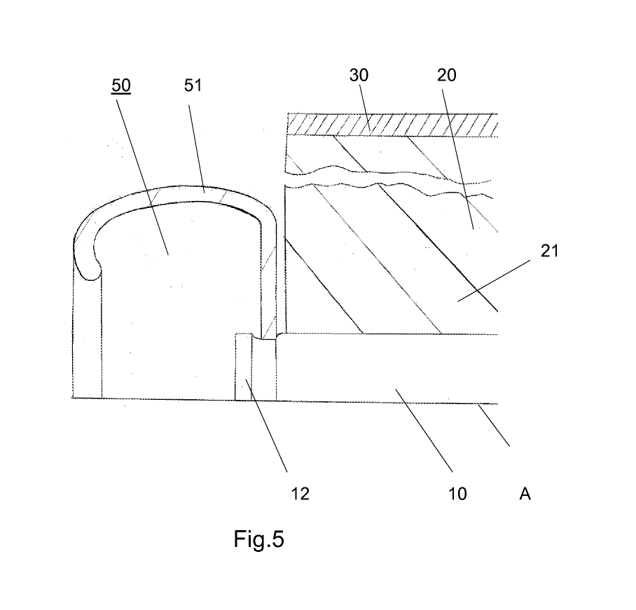

The same reference symbols also denote functionally identical parts in all of the Figures. FIG. 5 shows a part, illustrated in FIGS. 2 to 4, of an electrical component in the form of a barrier insulator in accordance with an exemplary embodiment of the present disclosure. FIG. 5 shows that, when the electrical component is in the form of a barrier insulator or a gas-insulated, metal-encapsulated high-voltage installation, the electrical conductor 10 can be fastened in the insulating body 20, similarly to the above-described bushings, and can be inserted into the metal encapsulation (not illustrated) with the aid of the mounting flange 30 and held at a defined distance from the encapsulation. The control electrode 50 can be fastened at the left-hand end 12 of the electrical conductor 10 guided through the disk-shaped insulating body 20. At this end, the electrical conductor 10 can be electrically conductively connected to an electrical conductor of the high-voltage installation, which electrical conductor can be arranged in the metal encapsulation and can be guided along the axis A, for example by means of plugging. Correspondingly, a further control electrode can also be arranged at the right-hand end (not illustrated) of the electrical conductor 10 which is passed out of the disk 20. As can be seen, the control electrode 50 can be connected to the electrical conductor 10 by being snapped on, e.g., detachably. In another exemplary embodiment, the control electrode 50 can also be connected to the electrical conductor 10 in non-detachable fashion. The dome 51 can then be manufactured during casting of the free-flowing polymer composition intended for the manufacture of the insulating body 20. The solid polymer composition 21 of the dome 51 then embeds the end 12 of the electrical conductor 10 form the non-detachable connection.

Depending on the profile of specifications of the electrical component, the control electrode 50 can be attached to the lower or left-hand end 12 or to the upper or right-hand end 11 of the electrical conductor 11, or a respective control electrode can be fastened to each of the two ends 11, 12.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

10 Electrical conductor
11, 12 Ends of electrical conductor
11a Flange
13 Ring groove
14 Mating thread
20 Insulating body
21 Cured solid polymer composition
30 Mounting flange
40 Capacitor winding
41 Capacitor foils
42 Insulating foil
50 Control electrode
51 Dome
52 Coating
53 Inner rim
54 Thread
60 Shield
A Axis

What is claimed is:

1. An electrical component for a high-voltage installation, comprising:
in a coaxial arrangement:
an electrical conductor that extends along an axis of the electrical component and is connected to a voltage potential;
a rigid insulating body, fastened on the electrical conductor and surrounding the electrical conductor, said rigid insulating body containing a solid polymer composition, which is formed by curing a preformed, free-flowing polymer composition;
a mounting flange fastened externally on the rigid insulating body and connected to ground potential, and
a dome-shaped control electrode, electrically conductively connected to one end of the electrical conductor, and is configured to control an electric field between the electrical conductor and the mounting flange during operation,
wherein the control electrode is connected non-detachably to the electrical conductor, the control electrode having a dimensionally stable dome including the solid polymer composition of the rigid insulating body, and a coating including a cured, electrically conductive enamel is formed at least on the outwardly pointing surface of the dome.

2. The electrical component as claimed in claim 1, wherein the one end of the electrical conductor, connected to the control electrode, is embedded in the control electrode.

3. The electrical component of claim 2, wherein the control electrode includes a casted dome.

4. The electrical component as claimed in claim 1, wherein the control electrode is fastened to the one end of the electrical component.

5. The electrical component as claimed in claim 1, comprising:
a capacitor winding embedded in the cured, solid polymer composition of the rigid insulating body, said capacitor winding including capacitor foils which are electrically insulated from one another and which are held at a distance from one another in a radial direction by an insulating foil wound around the axis of the electrical component or by a plurality of layers of a filament-wound winding body which are guided around the axis.

6. The electrical component as claimed in claim 1, wherein the coaxial arrangement is a bushing or a barrier insulator of a high-voltage installation.

7. An electrical component for a high-voltage installation, comprising:
in a coaxial arrangement:
an electrical conductor that extends along an axis and connected to a voltage potential;
a rigid insulating body, fastened on the electrical conductor and surrounding the electrical conductor, said rigid insulating body containing a solid polymer composition, which is formed by curing a preformed, free-flowing polymer composition;
a mounting flange fastened externally on the rigid insulating body and connected to ground potential, and
a control electrode, electrically conductively connected to the electrical conductor and fastened to one end of the electrical conductor, and is configured to control an electric field between the electrical conductor and the mounting flange during operation,
wherein the control electrode is elastically deformable and has a dome including an elastomeric plastic, and a coating including a cured, electrically conductive or electrically nonconductive enamel formed at least on an outwardly pointing surface of the dome.

8. The electrical component as claimed in claim 7, wherein the elastomeric plastic is electrically conductive and includes at least one filler having electrically conductive particles.

9. The electrical component as claimed in claim 8, wherein the control electrode includes a dome that is connected non-detachably to the electrical conductor.

10. The electrical component as claimed in claim 8, wherein the control electrode is detachably connected to the electrical conductor.

11. The electrical component as claimed in claim 10, wherein the control electrode includes a dome and a shield, which are formed on the insulating body together, include an electrically nonconductive elastomeric plastic, which is formed during manufacture of the component by curing a free-flowing starting composition introduced into a casting mold.

12. The electrical component as claimed in claims 8, wherein the elastomeric plastic contains silicone or ethylene propylene diene monomer (EPDM).

13. The electrical component as claimed in claim 12, wherein the detachable connection is in the form of a snap-action or screw-type connection.

14. The electrical component as claimed in claim 7, wherein the elastomeric plastic is electrically nonconductive and the coating is electrically conductive.

15. The electrical component as claimed in claims 14, wherein the elastomeric plastic contains silicone or ethylene propylene diene monomer (EPDM).

16. The electrical component as claimed in claim 14, wherein the control electrode is detachably connected to the electrical conductor.

17. The electrical component as claimed in claim 12, wherein the dome is connected non-detachably to the electrical conductor.

18. The electrical component as claimed in claims 7, wherein the elastomeric plastic contains silicone or ethylene propylene diene monomer (EPDM).

19. The electrical component as claimed in claim 18, wherein the control electrode is detachably connected to the electrical conductor.

20. The electrical component as claimed in claim 7, wherein the control electrode is detachably connected to the electrical conductor.

21. The electrical component as claimed in claim 7, wherein the control electrode includes a dome that is connected non-detachably to the electrical conductor.

22. The electrical component as claimed in claim 21, wherein the non-detachable connection is an adhesive connection or the one end of the electrical conductor connected to the control electrode is embedded in a dome of the control electrode
